(19) United States
(12) Patent Application Publication
(10) Pub. No.: US 2014/0297629 A1
(43) Pub. Date: Oct. 2, 2014

(54) SYSTEM AND METHOD FOR CATEGORIZING A CONTENT OBJECT BY GEOGRAPHICAL LOCATION OF THE CONTENT OBJECT

(71) Applicant: INTERNATIONAL BUSINESS MACHINES CORPORATION, Armonk, NY (US)

(72) Inventor: Lijing E. Lin, Irvine, CA (US)

(73) Assignee: International Business Machines Corporation, Armonk, NY (US)

(21) Appl. No.: 13/850,317

(22) Filed: Mar. 26, 2013

(51) Int. Cl. G06F 17/30

(52) U.S. Cl. CPC G06F 17/30241
USPC 707/724

(57) ABSTRACT

An approach for categorizing a content object by geographical location of the content object. In one embodiment, a first computer receiving a content object and geographical location associated with the content object from a second computer. The first computer further generates a container for the geographical location of the content object if such container does not exist. The first computer also generates a record of the content object. Further, the first computer generates a record of the content object. The first computer also classifies the record of the content object based on the geographical location. The first computer files the record of the content object to the container.

### FIELD OF THE INVENTION

The present invention relates generally to records management systems, and more particularly to generating containers of a content object by geographical location, and categorizing a record of the content object by the geographical location based on a geographical location the content object is captured by a mobile device.

### BACKGROUND

Records management systems, including, for example, IBM® InfoSphere®Enterprise records (IBM and InfoSphere are trademarks of International Business Machines, in the United States, other countries, or both), provide accurate, secure, and reliable maintenance for records of both electronic information and physical entities. The records have metadata, including, for example, a file that references and contains information about the electronic information and physical entities. The records can be created to place the electronic information and physical entities under compliance control of corporations, government, or one or more individuals, who can specify know how the electronic information and physical entities are to be stored, accessed, and eventually disposed of. Further, the metadata is in the form of record properties, such as media type, format, author, or subject. The electronic information might be a single file, or a set of related of related files that can be treated as one object, such as an email message and its attachments.

### SUMMARY

In one embodiment, a method for categorizing a content object by geographical location of the content object is provided. The method comprises a first computer receiving a content object and geographical location associated with the content object from a second computer. The method further comprises the first computer generating a container for the geographical location of the content object if such container does not exist. The method further comprises the first computer generating a record of the content object. The method further comprises the first computer classifying the record of the content object based on the geographical location. The method further comprises the first computer filing the record of the content object to the container.

In another embodiment, a computer system for categorizing a content object by geographical location of the content object is provided. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system comprises program instructions to receive at a first computer, content object and geographical location associated with the content object from a second computer. The computer system further comprises program instructions to generate a container for the geographical location of the content object if such container does not exist. The computer system further comprises program instructions to generate a record of the content object. The computer system further comprises program instructions to classify the record of the content object based on the geographical location. The computer system further comprises program instructions to file the record of the content object to the container.

In yet another embodiment, a computer program product for categorizing a content object by geographical location of the content object is provided. The computer program product comprises one or more computer-readable tangible storage devices and program instructions stored on at least one of the one or more storage devices, the program instructions comprising. The computer program product further comprises program instructions to receive at a first computer, a content object and geographical location associated with content object from a second computer. The computer product further comprises program instructions to generate a container for the geographical location of the content object if such container does not exist. The computer program product further comprises program instructions to generate a record of the content object. The computer program product further comprises program instructions to classify the record of the content object based on the geographical location. The computer program product further comprises program instructions to file the record of the content object to the container.

### BRIEF DESCRIPTION OF THE SEVERAL VIEWS OF THE DRAWINGS

Novel characteristics of the invention are set forth in the appended claims. The invention itself, however, as well as preferred mode of use, further objectives, and advantages thereof, will be best understood by reference to the following detailed description of the invention when read in conjunction with the accompanying Figures, wherein like reference numerals indicate like components, and:

FIG. 1 is a functional block diagram of a content categorizing system in accordance with embodiments of the present invention.

FIG. 2 is a functional block diagrams illustrating program components of mobile devices in accordance with embodiments of the present invention.

FIG. 3 is a functional block diagram illustrating components of a records management server, in accordance with embodiments of the present invention.

FIG. 4 is a functional block diagram illustrating a file plan system model of a records management server program, in accordance with embodiments of the present invention.

FIG. 5 is a flowchart depicting steps performed by a records management server program in accordance with embodiments of the present invention.

FIG. 6 illustrates a block diagram of components of a computer system in accordance with embodiments of the present invention.

### DETAILED DESCRIPTION

Embodiments of the present invention comprise functionality generating one or more content objects, and geographical location of the generated one or more content objects by a mobile device. The mobile device transmits the one or more content objects and the associated geographical location of the one or more content objects to a records management server. In one embodiment, the records management declares the transmitted one or more content objects as a record, categories the record by the geographical location, and classifies the one or more content objects based on the geographical location. The records management server further provides mechanisms to categorize the records into a file plan which contains records categories of the one or more content objects, store the one or more content objects in a content management system of the records management server, automate tracking or retention of the content objects, and initiate a disposal process of the records of the content objects.

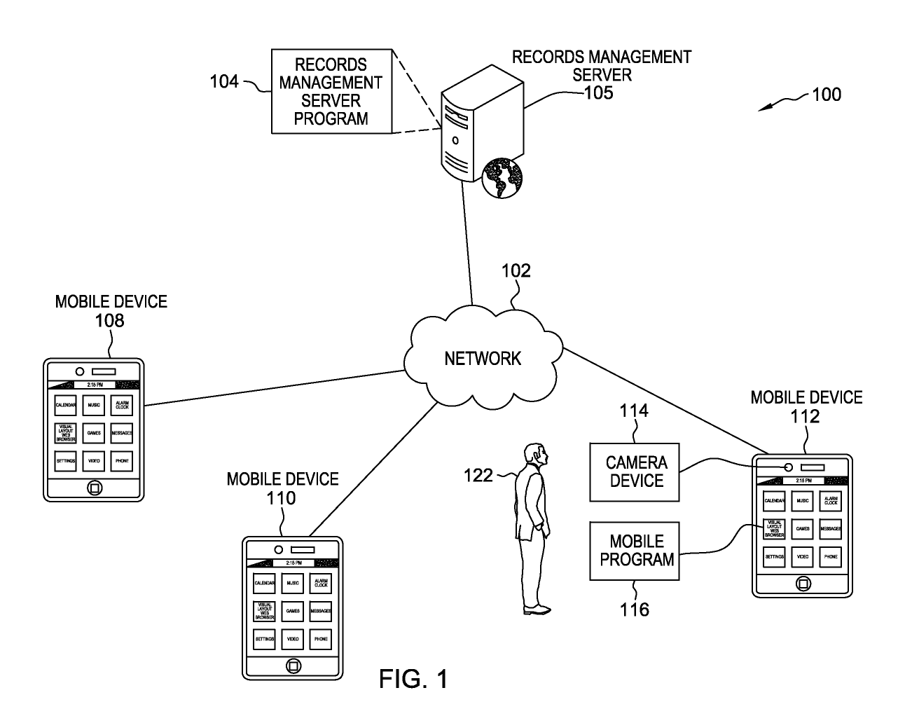

Embodiments of the present invention will now be described in detail with reference to the accompanying drawings. Further aspects of the present invention will now be described in conjunction with the Figures. Referring to FIG. 1, content categorizing system 100 for declaring one or more content objects of a mobile device as a record, categorizing the records of the one or more content objects, and classifying the one or more objects based on the geographical location is shown.

Content categorizing system 100 comprises network 102, records management server 105 and mobile devices 108, 110, 112. Records management server 105 and mobile devices 108, 110, 112 are interconnected over network 102. Mobile devices 108, 110, 112 can be any portable device which provides computing and information storage and retrieval capabilities, including, for example, a handheld device or handheld computer, pocket PC, connected organizer, electronic book (eBook) reader, a personal digital assistant (PDA), or a smart phone, such as, for example, Blackberry® or iPhone® or other portable devices.

Each of mobile devices 108, 110, 112 comprises mobile program 116 and camera device 114. Mobile program 116 creates content objects, including, photo or video contents captured by requestor 122 via camera device 114, together with geographical location of the captured content objects, and transmits the captured content object together with its associated geographical location to records management server 105. Mobile devices 108, 110, 112 includes a location server mechanism to track the geographical location of the captured content objects.

Records management server 104 is a server based records management system, including, for example, a web server program, or records management server for maintaining records of captured content objects, and its associated geographical location according to a file plan. Records management server 105 generates containers of captured content objects of mobile devices 108, 110, 112 by geographical locations of the content objects, and categorizes records of the captured content objects into different containers of records management server 105. For instance, records management server 105 declares the content objects of mobile devices 108, 110, 112, as a record, categorizes the records of the one or more content objects, and classifies the one or more objects based on the geographical locations. The generated records by records management server program 104 includes the content objects. The records being generated, however, may include the geographical locations. According to one aspect, the geographical location can be utilized by records management server 105 to categorize the records into the different containers.

Records management server program 104 can also represent a “cloud” of computers interconnected by one or more networks, where records management server program 104 can be a primary server of a computing system utilizing clustered computers when accessed through network 102. For example, a cloud computing system can be an implementation of transmission of captured image contents across object stores and repositories of records management server program 104. Records management server 104 includes records management program 116.

Records management server program 104 generates record containers of the content objects, and categorizes the generated records into different containers based on the geographical locations of the content objects of records management server 105. Records management server program 104 can be for example, IBM® Enterprise Records application. Records management server program 105 stores, retrieves, and disposes of records of the content objects in the objects, and the associated geographical location, and the categorized records based on the associated geographical locations of the content objects according to compliance policies. Records management server program 104 also defines object classes of records management server program 104 that represent the file plan for categorizing the content objects of mobile devices 108, 110, 112 into the containers, based on the geographical location of the content objects.

Network 102 includes one or more networks of any kind that can provide communication links between various devices and computers connected together within content categorizing system 100. Network 102 also includes connections, such as wired communication links, wireless communication links, or fiber optic cables. Network 102 can be implemented as a number of different types of networks, including, for example, a local area network (LAN), wide area network (WAN) or a packet switched telephone network (PSTN), or some other networked system. Network 102 can include the Internet representing a worldwide collection of networks.

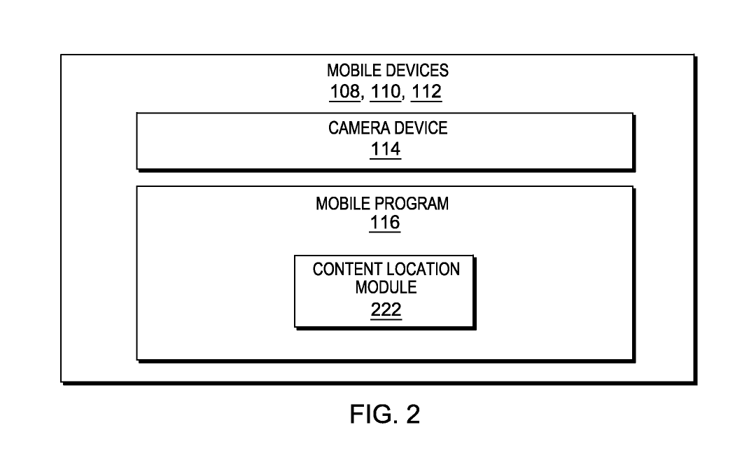

FIG. 2 is a functional block diagram illustrating components of mobile devices 108, 110, 112, in accordance with an embodiment of the present invention.

Mobile program 116 captures photo or video via camera device 114. For example, requestor 122 captures the photo or video image on camera device 114, at a scene of, for example, crime or other incident, in real time, wherein the captured photo or video of the incident can be examined or analyzed by law enforcement or medical departments, such as, medical units, including, for example, forensic lab or coroner's lab. The photo or video image represents a depiction of a scene visible to camera device 114 that is generated by mobile devices 108, 110, 112, once requestor 122 captures the photo or video via camera device 114. Mobile program 116 comprises content location module 222.

Content location module 222 tracks geographical locations of captured content objects. Once requestor 122 captures the content object, location of the content object is traced, wherein the traced location together with the content objects are transmitted to records management server program 104 for declaration of the content and categorization of the content objects. Upon receiving, records management server program 104 declares the content as records, and categorizes the content into different containers based on the associated geographical locations. For instance, records management server program 104 declares all captured contents of a crime or incident into the same records container of the content object, based on the geographical location. In addition, mobile program 116 transmits the captured content objects to records management server program 104 without delay or potential loss of the content objects, in accordance with embodiments of the present invention.

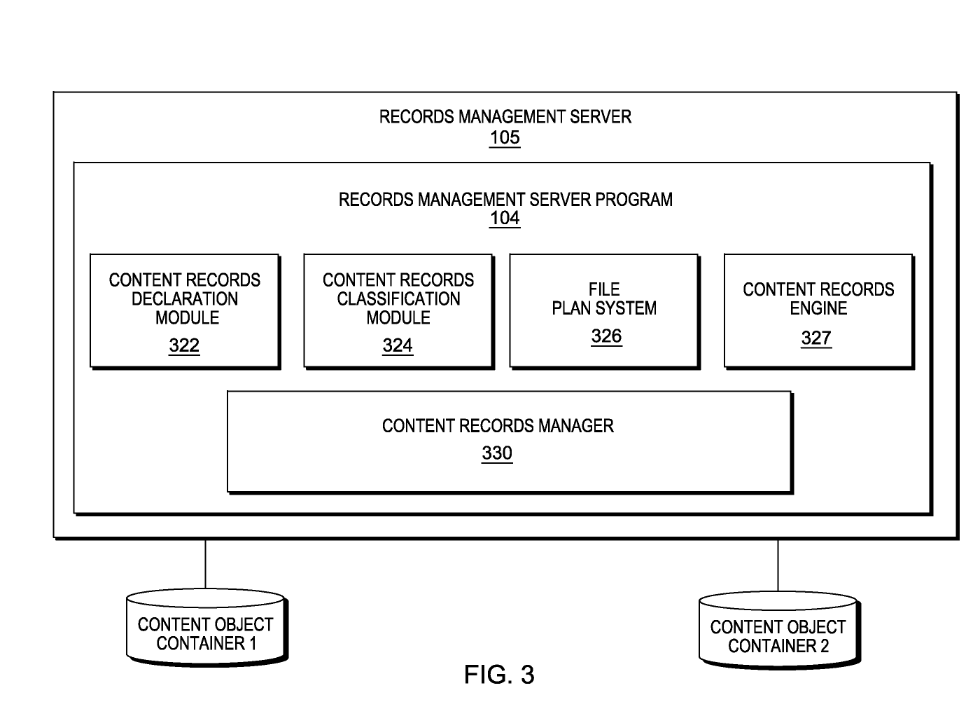

FIG. 3 is a functional block diagram illustrating components of records management server 105, in accordance with embodiments of the present invention.

Records management server program 104 maintains records of captured contents objects of mobile devices 108, 110, 112 and associated geographical location of the captured content objects according to a file plan, based on compliance control policies to store, retrieve, deposit as well as to audit and perform access control of the content objects in of records management server 105. Records management server program 104 generates storage for the content objects in content object containers 1, 2 based on geographical location in which the content objects where captured by camera device 114. Further, records management server program 104 categorizes records by the geographical location in content object containers 1, 2 that specifies where the content object was captured of the captured content objects into content object containers 1, 2. Records management server program 104 includes content records declaration module 322, content records classification module 324, file plan system 326, content records engine 327, and content records manager 330.

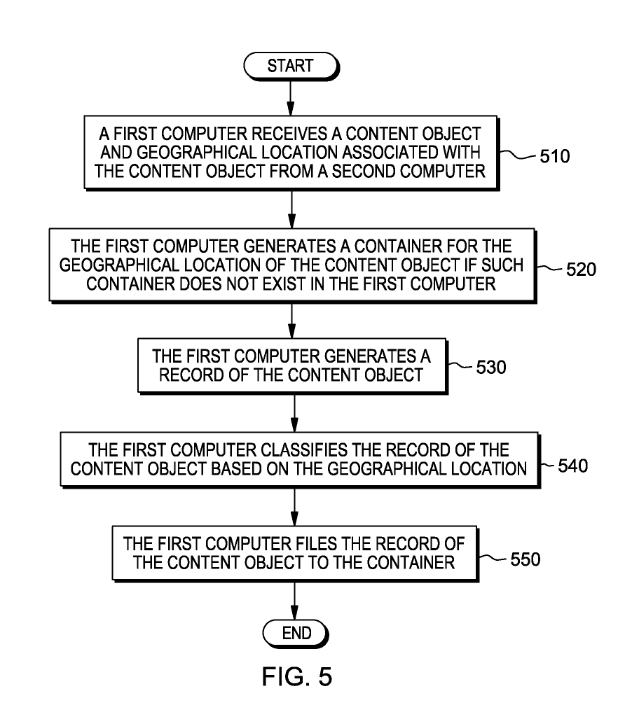

Content objects are transmitted to records management server program 104 from mobile program 116 of mobile devices 108, 110, 112. In response, records management server program 104 declares the transmitted content objects as records via content records declaration module 322, and classifies the record of the content objects via content record classification module 324 according to file plan system 326, which may include, for instance, categorizing the record of the content objects into content object containers 1, 2 of file plan system 326, wherein file plan system 326 provides records categories via content object containers 1,2 for the content objects, storage for the content objects, audit and access control policies for the content objects, and/or destruction or preservation of the content objects based on compliance policies that can be defined in content records manager 330. For example, one or more file plans 326 of records management server program 104 includes an outline/definition for records management of the content objects based on hierarchically arranged set of categories, records folders of the content objects, and records volumes of the content objects as described in FIG. 5. Content records engine 327 provides the repository server of content object containers 1, 2 for storing content objects in file plans 326, and is responsible for enforcing security and auditing of the transmitted content objects. Content records manager 330 further enables requestor 122 to create and manage file plan system 326 in content object containers 1, 2, wherein requestor 122 can utilize a location service in mobile devices 108, 110, 112 to automate record container generation and records categorization of the content objects by location of where the content object was captured. In one example, file plan system 326 hierarchically arranges the transmitted content objects for declaration by content record declaration module 322, and generation of the location service of the content objects in content object containers 1, 2. Content records manager 330 further creates and manages disposition schedules and records folders of file plan system 326, configures records management server program 104 to specify content object classes and properties to manage or search for categories, including, folders and records of content objects, with file plan system 326 hierarchical tree structure, in accordance with embodiments of the present invention.

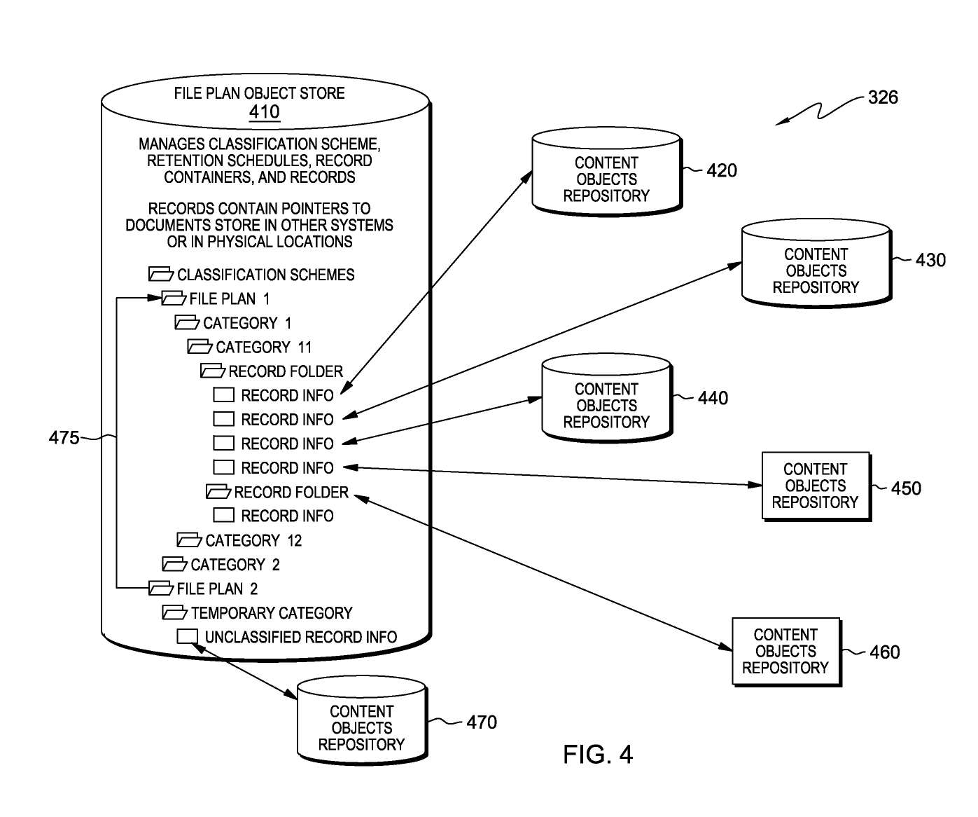

FIG. 4 is a functional block diagram illustrating file plan system 326 model of records management server program 104, in accordance with embodiments of the present invention.

File plan system 326 is used to manage declaration of records of transmitted content objects of mobile device 108, 110, 112, across object stores and repositories of records management server program 104. File plan system 326 utilizes file plan object store 410 to manage classification schemes, retention schedules, and recording of the transmitted content objects. File plan system 326 also incorporates a category hierarchy which may be the primary classification for records of content objects, and may include categories, as well as, various types of folders and corresponding volumes. More particularly, file plan system 326 may incorporate a classification scheme, record category, record folder, record part or record type that can be used to manage the record. For example, the category hierarchy may also include a tree structure defining how records are organized, and the category hierarchy may also propagate security and support disposition schedules. The category hierarchy may include a flexible hierarchical structure that is designed to fit the unique needs of an organization. Furthermore, the category hierarchy of file plan system 326 may determine the scheme for classifying records in combination with events or business context so that the records may be automatically classified by a records management system, without user intervention. The category hierarchy may also be determined by business function. For example, a category hierarchy may be organized according to a function/activity/transaction model wherein the first level determines functional groupings, the second level determines activities within the function, and the lowest level represents a transaction. The hierarchy may also be designed to facilitate access. In this manner, security may be more easily controlled, by for example, requestor 122 or an administrator, wherein requestor 122 gains access to provide, for example, maintenance or compliance policy control of the transmitted content objects in containers 1, 2 of file plan system 326. File plan system 326 may also be designed so that each folder in the category is a client file that contains that particular client's records, and once the client folder is closed, cutoff may be triggered so that active use of the record ends and it begins its retention period. In another aspect, file plan system 326 may be designed so that different types of records of the content objects are filed into different folders. In yet another aspect, file plan system 326 may be designed so that each sub-category represents a project, and each project may have a collection of folders to manage different records related to the project.

An external event related to a project milestone may be used to trigger cutoff so that active use of the record ends and the retention period begins. The record category may be added to the root of file plan system 326. The record category may also be added as a subcategory to an existing category to establish a hierarchy. The required properties of a category may be the category name which may be descriptive of the category, the category identifier which may be a more cryptic string identifier often containing a numeric code, and a reviewer which may default to the user who is adding the category.

A record folder may be added to a category. Conceptually, the record folder may be the most common level for managing records of the content objects. The required properties for a folder may include the folder class such as a content engine object class defining the type of folder. The folder class may be defined by the data model. The folder properties may also include a name, identifier and reviewer much like the record category. For example, a record folder may not contain sub-folders, but may contain volumes of the content objects. The first volume may be automatically added when the record folder is created, and a name may be automatically generated based on the folder name. When a new volume is added, the previous volume may be automatically closed. Volumes may be used to partition groups of records, whether similar or not. For example, a record folder may contain all invoices while volumes may be used to partition by month. A volume may be required to include a reviewer, which may default to the user requesting the volume.

As shown in FIG. 4, the data objects and content objects repository 420, 430, 440, 450, 460 may be configured in conformance with the classic model of a software object that has been developed in object-oriented programming to include one or more attributes and one or more methods. A broad variety of characteristics may be assigned as attributes to the file plan object store 410. For example, these objects may incorporate attributes that are related to the records that are embodied in the software object such as a name for the record, a description of the record, the type of record, an identification of the holders of the record.

Audit or compliance policy information may also be contained as an attribute relating to the record such as who accesses an object, for instances, when it is modified by requestor 122, whether requestor 122 is authorized to modify the system, whether requestor 122 can generate records for the content objects that are related to the object or repository of file plan system 326, and when these events take place. Electronic signatures that may have been procured in connection with an object store such as object store 410 may be contained as an attribute. Notifications that should be issued upon a change in an aspect of a data object, security information relating to a data object, status information that is associated with the record (such as lost item), relevant dates (e.g., creation date, expiry date, and/or key timelines, including multiple, periodic or cyclical information), and relationships between the record software object and other components may be contained as attributes. Although each of these characteristics may be illustrated as an attribute of the object, each of these may also or instead be stored as separate components or objects in the record management system.

Furthermore, data model of file plan system 326 includes pointers from the file plan object store 410 to documents stored in other systems or locations. One such pointer is to object stores related to content object repositories 420, 430 which are the main record types and thus use more space. The data model also includes pointers to an image service repository of content object repository 440, a cabinet repository for physical documents of content objects repository 450 that may be located in cabinets, as well as, a box repository for physical documents of content object repository 460 that may be located in boxes. These records are all classified under one particular file plan of file plan system 326, which may be one of several or many file plans employed by file plan system 326 for declaring records of content objects of mobile device 108, 110, 112. The file plan may be used to classify a record upon declaration of the record in a conventional manner, or it can be used to classify a record that was declared with deferred classification, in accordance with embodiments of the invention.

A second file plan can be used to point to content object repository 470 which have been declared as records, but not yet given any record classification under the file plan. Although shown here in one instance, the records designated in file plan system 326 of content objects of repository 470 may be in any of repositories 420, 430, 440, 450, and 460, or elsewhere. The declared content objects records may move to another file plan, as indicated by line 475, upon the occurrence of a classification event where, for example, additional information is added to the record, allowing it to be classified into another file plan. This design provides for a file plan of file plan system 326 that incorporates an intuitive scheme that can be readily used by the records administrator to generate a file plan. Based on the structure of file plan system 326, requestor 122 or a records administrator may customize file plan system 326 to provide declaring or records for the content objects, and also provide maintenance and compliance policy mechanism for auditing or accessing the content objects.

Methods may be related to the records, including methods that include or relate to retention and disposition rules, timed events, notifications, reports and trends and forecasts. Each of these methods may constitute software subroutines that initiate, alter or interrupt one or more processes. As with the attributes, the methods may be stored separately from the file plan object store 410 or data objects of content objects, in accordance with the present invention.

FIG. 5 is a flowchart depicting steps performed by records management server program 104, in accordance with embodiments of the present invention.

In step 510, records management server program 104 receives a contents object and geographical location associated with the content object from mobile program 116 of mobile devices 108, 110, 112. In step 520, records management server program 104 generates content object containers 1, 2 for the geographical location of the content object. For example, records management server program 104 generates content object containers 1, 2 for the geographical location of the content object if content object containers 1, 2 does not exit in records management server 105. In step 530, records management server program 104 generates a record of the content object. In step 540, records management server program 104 classifies the record of the content object based on the geographical location of the content object. In step 550, records management server program 104 files the record of the content object to content object containers 1, 2, of file plan system 326 of records management server 105.

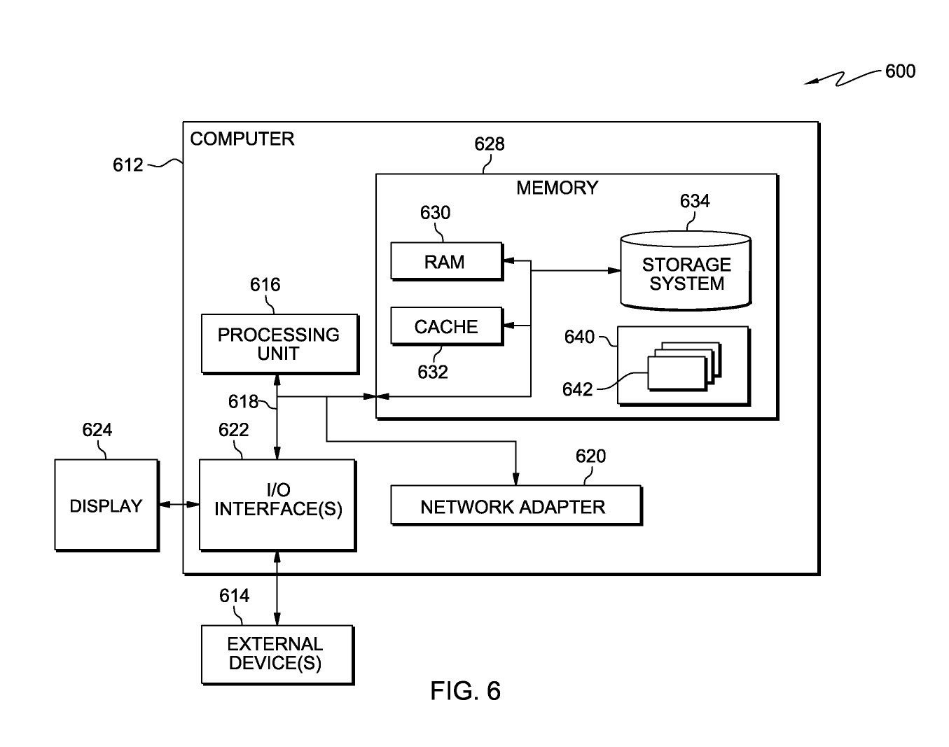

FIG. 6 is a functional block diagram of a computer system, in accordance with an embodiment of the present invention.

Computer system 600 is only one example of a suitable computer system and is not intended to suggest any limitation as to the scope of use or functionality of embodiments of the invention described herein. Regardless, computer system 600 is capable of being implemented and/or performing any of the functionality set forth hereinabove. In computer system 600 there is computer 612, which is operational with numerous other general purpose or special purpose computing system environments or configurations. Examples of well-known computing systems, environments, and/or configurations that may be suitable for use with computer 612 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of mobile devices 108, 110, 112 and records management server 105 can include or can be implemented as an instance of computer 612.

Computer 612 may be described in the general context of computer system executable instructions, such as program modules, being executed by a computer system. Generally, program modules may include routines, programs, objects, components, logic, data structures, and so on that perform particular tasks or implement particular abstract data types. Computer 612 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 6, computer 612 is shown in the form of a general-purpose computing device. The components of computer 612 may include, but are not limited to, one or more processors or processing units 616, memory 628, and bus 618 that couples various system components including memory 628 to processing unit 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 612 typically includes a variety of computer system readable media. Such media may be any available media that is accessible by computer 612, and includes both volatile and non-volatile media, and removable and non-removable media.

Memory 628 includes computer system readable media in the form of volatile memory, such as random access memory (RAM) 630 and/or cache 632. Computer 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Mobile program 116 and records management server program 104 can be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein. Each one of mobile program 116 and records management server program 104 are implemented as or are an instance of program 640.

Computer 612 may also communicate with one or more external devices 614 such as a keyboard, a pointing device, etc., as well as display 624; one or more devices that enable a user to interact with computer 612; and/or any devices (e.g., network card, modem, etc.) that enable computer 612 to communicate with one or more other computing devices. Such communication occurs via Input/Output (I/O) interfaces 622. Still yet, computer 612 communicates with one or more networks such as a local area network (LAN), a general wide area network (WAN), and/or a public network (e.g., the Internet) via network adapter 620. As depicted, network adapter 620 communicates with the other components of computer 612 via bus 618. It should be understood that although not shown, other hardware and/or software components could be used in conjunction with computer 612. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains, or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for embodiments of the present invention may be written in any combination of one or more programming languages, including an object oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product method for categorizing a content object by geographical location of the content object in a records management server have been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A method for categorizing a content object by geographical location of the content object, the method comprising the steps of:
a first computer receiving a content object and geographical location associated with the content object from a second computer;
the first computer generating a container for the geographical location of the content object if such container does not exist;
the first computer generating a record of the content object;
the first computer classifying the record of the content object based on the geographical location; and
the first computer filing the record of the content object to the container.

2. The method according to claim 1, wherein the step of receiving a content object and geographical location associated with the content object, further comprises:
the second computer generating the content object and geographical location of the content object on the second computer; and
the second computer transmitting the generated content object and geographical location of the content object to the first computer.

3. The method according to claim 2, wherein the second computer transmits the content object to the first computer without delay or potential loss of the content object.

4. The method according to claim 1, wherein the step of classifying the record based on the geographical location, further comprises:
the first computer categorizing the record of the content object by the geographical location associated with content object according to a file plan; and
the first computer managing the records of the content object and geographical location associated with the content object according to the file plan based on compliance control policies for the records defined for content object.

5. The method according to claim 4, wherein the compliance control policies includes auditing and access control of the records and the associated geographical locations of the content object of the records according to the file plan.

6. The method according to 4, wherein the first computer is a records management server, and wherein the records management server provides retention, scheduling, preservation, and disposition procedures for the records by supporting a centralized management of the compliance control policies of the records.

7. The method according to claim 1, wherein the second computer is a mobile device, wherein the mobile device captures the content object, and wherein the content objects includes photo or video images.

8. A computer system for categorizing a content object by geographical location of the content object, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to receive at a first computer, content object and geographical location associated with the content object from a second computer;
program instructions to generate a container for the geographical location of the content object if such container does not exist;
program instructions to generate a record of the content object;
program instructions to classify the record of the content object based on the geographical location; and
program instructions to file the record of the content object to the container.

9. The computer system according to claim 8, wherein program instructions to receive at a content object and geographical location associated with the content object, further comprises:
program instructions to generate at a second computer the content object and geographical location of the content object; and
program instructions to transmit from the second computer the generated content object and geographical location of the content object to the first computer.

10. The computer system according to claim 8, wherein the second computer is a mobile device, wherein the mobile device captures the content object, and wherein the content objects includes photo or video images.

11. The computer system according to claim 8, wherein program instructions to classify the record based on the geographical location, further comprises:
program instructions to categorize the record of the content object by the geographical location associated with content object according to a file plan; and
program instructions to manage the records of the content object and geographical location associated with the content object according to the file plan based on compliance control policies for the records defined for content object.

12. The computer system according to claim 11, wherein the compliance control policies includes auditing and access control of the records and the associated geographical locations of the content object of the records according to the file plan.

13. The computer system according to claim 11, wherein the first computer is a records management server, and wherein the records management server provides retention, scheduling, preservation, and disposition procedures for the records by supporting a centralized management of the compliance control policies of the records.

14. A computer program product for categorizing a content object by geographical location of the content object, the computer program product comprising:
one or more computer-readable tangible storage devices and program instructions stored on at least one of the one or more storage devices, the program instructions comprising:
program instructions to receive at a first computer, a content object and geographical location associated with content object from a second computer;
program instructions to generate a container for the geographical location of the content object if such container does not exist;
program instructions to generate a record of the content object;
program instructions to classify the record of the content object based on the geographical location; and
program instructions to file the record of the content object to the container.

15. The computer program product according to claim 14, wherein program instructions to receive at a first computer, a content object and geographical location associated with the content object, further comprises:
program instructions to generate at a second computer the content object and geographical location of the content object; and
program instructions to transmit from the second computer the generated content object and geographical location of the content object to the first computer.

16. The computer program product according to claim 15, wherein the second computer transmits the content object to the first computer without delay or potential loss of the content object.

17. The computer program product according to claim 14, wherein program instructions to classify the record based on the geographical location, further comprises:
program instructions to categorize the record of the content object by the geographical location associated with content object according to a file plan; and
program instructions to manage the records of the content object and geographical location associated with the content object according to the file plan based on compliance control policies for the records defined for content object.

18. The computer program product according to claim 17, wherein the compliance control policies include auditing and access control of the records and the associated geographical locations of the content object of the records according to the file plan.

19. The computer program product according to claim 17, wherein the first computer is a records management server, and wherein the records management server provides retention, scheduling, preservation, and disposition procedures for the records by supporting a centralized management of the compliance control policies of the records.

20. The computer program product according to claim 15, wherein the second computer is a mobile device, wherein the mobile device captures the content object, and wherein the content objects includes photo or video images.
